(19) United States
(12) Patent Application Publication
(10) Pub. No.: US 2023/0113176 A1
(43) Pub. Date: Apr. 13, 2023

(54) O2 Tree for Addressing Climate Change

(71) Applicant: Jocelyn Bruno, Cibolo, TX (US)

(72) Inventor: Jocelyn Bruno, Cibolo, TX (US)

(21) Appl. No.: 17/496,596

(22) Filed: Oct. 7, 2021

(51) Int. Cl. B01D 53/14; A41G 1/00

(52) U.S. Cl. CPC B01D 53/1475; B01D 53/1493; A41G 1/007; A41G 1/001; B01D 2257/504; B01D 2258/06; B01D 2279/40; B01D 2273/30; B01D 2256/12; B01D 2252/10

(57) ABSTRACT

An article of manufacture for providing an O₂ Tree for removing CO₂ gas from the atmosphere according to the present invention is disclosed.

### TECHNICAL FIELD

This application relates in general to an article of manufacture for providing an environmental treatment device, and more specifically, to an article of manufacture for providing an O₂ Tree for removing CO₂ gas from the atmosphere.

### BACKGROUND

Greenhouse gases trap heat and make the planet warmer. According to the U.S. Environmental Protection Agency (EPA), human activities are responsible for nearly all the increase in greenhouse gases in our atmosphere over the last 150 years. Since 1990, gross U.S. greenhouse gas emissions have increased by 2 percent. The largest source of greenhouse gas emissions from human activities in the U.S. is from burning fossil fuels for electricity, heat, and transportation. Land areas can act as a sink (absorbing CO₂ from the atmosphere) or a source of greenhouse gas emissions. Since 1990 in the U.S., managed forests and other lands are a net sink; they have absorbed more CO₂ from the atmosphere than they emit. With this in mind, we can manufacture artificial “trees” to be used in populated areas to absorb CO₂ from the atmosphere and release O₂.

Therefore, a need exists for an article of manufacture for providing an O₂ Tree for removing CO₂ gas from the atmosphere. The present invention attempts to address the limitations and deficiencies in prior solutions according to the principles and example embodiments disclosed herein.

### SUMMARY

In accordance with the present invention, the above and other problems are solved by providing an article of manufacture for an O₂ Tree for removing CO₂ gas from the atmosphere according to the principles and example embodiments disclosed herein.

In one embodiment, the present invention is an article of manufacture for providing an O₂ Tree for removing CO₂ gas from the atmosphere. The O₂ Tree includes a capture chamber having a CO₂/O₂ processing unit, an intake port into the capture chamber, an exhaust port from the capture chamber, and the CO₂/O₂ processing unit having a captured CO₂ transfer port. The CO₂/O₂ processing unit includes a fan having a fan motor for moving air into and out of the capture chamber through the intake port and the exhaust port, a filter element for binding with the CO₂ within the capture chamber, a heater element for raising the temperature of the filter element to release the bound CO₂ from the filter element generating captured CO₂, and a controller. The controller being configured to cause the CO₂/O₂ processing unit to open the intake port and the exhaust port, activate the fan motor to draw atmospheric air into the capture chamber, close the intake port and the exhaust port and deactivate the fan motor after a period of time, activate the heater to raise the filter temperature, and open the captured CO₂ transfer port causing the captured CO₂ to pass out of the capture chamber.

In another aspect of the present invention, the filter element utilizes graphene to bind the CO₂ to the filter element.

In another aspect of the present invention, the O₂ Tree further includes a solar power dome having one or more solar power arrays, a power supply for suppling electrical power to the O₂ Tree, and one or more rechargeable batteries.

In another aspect of the present invention, the power supply recharges the one or more rechargeable batteries using the solar arrays.

In another aspect of the present invention, the power supply recharges the one or more rechargeable batteries using an external AC power source

In another aspect of the present invention, the power supply uses the rechargeable batteries to provide electrical power to the O₂ Tree when the external AC power source is unavailable

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates example embodiments of an article of manufacture providing a device for removing CO₂ gas from the atmosphere according to the present invention.

FIG. 2 illustrates another example embodiment of an article of manufacture providing an O₂ Tree for removing CO₂ gas from the atmosphere according to the present invention.

FIG. 3 illustrates the example embodiments with an outside enclosure of the article of manufacture providing an O₂ Tree for removing CO₂ gas from the atmosphere according to the present invention

FIG. 4 illustrates a block diagram of an article of manufacture showing example embodiments of an article of manufacture providing an O₂ Tree for removing CO₂ gas from the atmosphere according to the present invention.

### DETAILED DESCRIPTION

This application relates in general to an article of manufacture for providing an environmental treatment device, and more specifically, to an article of manufacture providing an O₂ Tree for removing CO₂ gas from the atmosphere according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture providing a device for removing CO₂ gas from the atmosphere according to the present invention. The term user herein refers to one or more users.

The term “invention” or “present invention” refers to the invention being applied for via the patent application with the title “O₂ Tree for Addressing Climate Change.” Invention may be used interchangeably with CO₂ device.

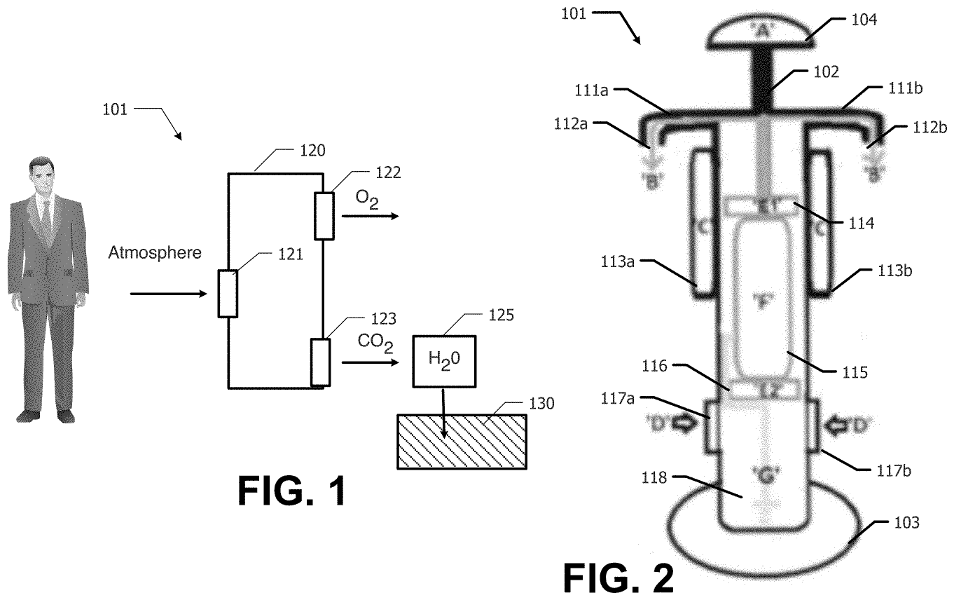

In general, the present disclosure relates to an article of manufacture providing an O₂ Tree for removing CO₂ gas from the atmosphere according to the present invention. To better understand the present invention, FIG. 1 illustrates example embodiments of an article of manufacture providing a device for removing CO₂ gas from the atmosphere according to the present invention. The O₂ Tree 101 is a small device that is similar in size to a large individual permitting the O₂ Trees to be located throughout a region inhabited by people. The O₂ Tree 101 is intended to be installed nationwide throughout all cities, towns, and residential neighborhoods, operating 24/7 to filter out CO₂ and deliver O₂.

An O₂ Tree 101 is a device designed to suck in air containing carbon dioxide (CO₂), direct the captured CO₂ to the earth, and output oxygen (O₂) The O₂ Tree 101 is built in a manner pleasing to the eye, and yet able to capture CO₂ and output O₂ at a far greater volume than real trees. The O₂ Tree 101 may operate on AC power and in the event of AC power failure, a rechargeable battery may be used to provide power for continued operation until AC power is restored. In the event of extended AC power loss, the rechargeable battery powers the unit until battery power is depleted to 10%, at which point, the O₂ Tree 101 powers down to allow the rechargeable battery to charge to 95%. Once the O₂ Tree 101 reaches this threshold, the O₂ Tree 101 powers up again. This CO₂ extraction processing cycle repeats until AC power is restored. In this manner, the O₂ Tree 101 ensures continued daily operation with off periods for battery recharging.

The O₂ Tree 101 operates by drawing atmospheric air into the device 101 through an input port 121. The atmospheric air includes both O₂ and CO₂ gases as well as other elements. The O₂ Tree 101 extracts the CO₂ from the atmospheric air and passes the CO₂ through a captured CO₂ output port 123 to be mixed with water 125. The O₂ gas and other constituent elements are expelled out a separate exhaust port 122. The water, having dissolved the CO₂ gas contained therein, may be stored into rock formations 130 for long term storage. Additional details regarding the O₂ Tree 101 are described below in reference to FIG. 2.

FIG. 2 illustrates another example embodiment of an article of manufacture providing an O₂ Tree for removing CO₂ gas from the atmosphere according to the present invention. The example embodiment of an O₂ Tree 101 shown in FIG. 2 is constructed using an internal frame structure 102, a support base 103, a solar power dome 104, and a pair of treated air exhaust lines each having its own exhaust port 112a-b. The O₂ Tree 101 further comprises a pair of rechargeable batteries 113a-b, a controllable exhaust valve 114, a CO₂/O₂ processing unit 115, a controllable intake valve 116, a pair of intake ports 117a-b, and a CO₂ storage unit 118.

The internal frame structure 102 supports all of the components within the O₂ Tree 101 as well as provides a path through the O₂ Tree 101 as the CO₂ is extracted from the air and processed for storage underground. The internal frame structure 102 also provides a path for the processed O₂ gas to reach the external exhaust ports 112a-b for returning the processed O₂ gas to the atmosphere.

The support base 103 is connected to the internal frame structure 102 to orient the O₂ Tree 101 into a desired position. The support base 103 also may include connections to external devices including external power and wastewater containing the dissolved CO₂ gas for storage.

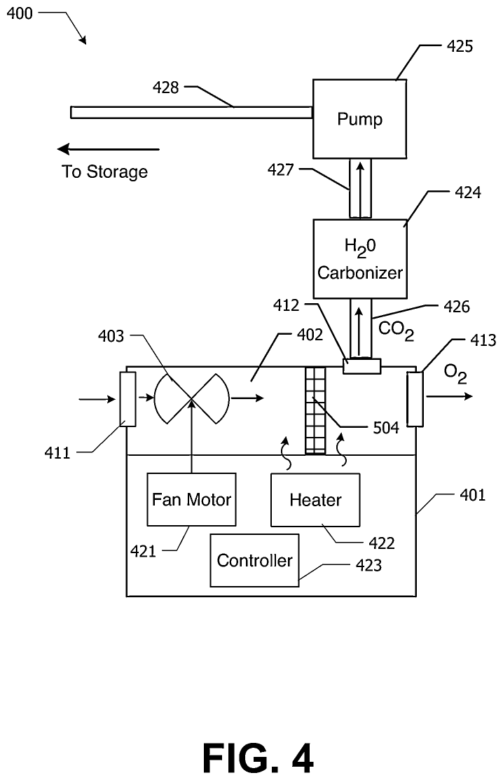

The solar power dome 104 is a solar array support containing one or more solar array devices as shown in FIG. 4 that provide electrical power to recharge the rechargeable batteries 113a-b as well as provide a backup power source to power the O₂ Tree 101 when AC power from an external source is unavailable. The solar power dome 104 may possess any shape that supports the solar arrays 414 and directs the solar arrays toward the sun as needed.

The pair of treated air exhaust lines 111a-b, each having its own exhaust port 112a-b, is connected to the controllable exhaust valve 114 to permit the processed gas to be vented out of the exhaust ports 112a-b into the surrounding environment.

The pair of rechargeable batteries 113a-b store electrical energy that may be used to power the O₂ Tree 101 when external power in not available. The pair of rechargeable batteries 113a-b may be charged using the external power source when it is available and may be charged by the solar arrays 414 coupled to the solar power dome 104.

The controllable exhaust valve 114 opens and closes to permit the processed air to flow to the exhaust ports 112a-b. As disclosed in more detail in reference to FIG. 4, the atmospheric air is passed into the CO₂/O₂ processing unit 115 where the CO₂ gas is captured. The controllable exhaust valve 114 is closed to permit the CO₂/O₂ processing unit 115 to vent the captured CO₂ gas into the CO₂ storage unit 118 for further processing for long term storage.

The CO₂/O₂ processing unit 115 accepts atmospheric air and captures the CO₂ contained within the atmospheric air before venting the processed air through the exhaust ports 112a-b. The CO₂/O₂ processing unit 115 cycles through a set of operating modes as disclosed in detail in regard to FIG. 4. Once the CO₂/O₂ processing unit 115 has captured a sufficient amount of CO₂ gas, the controllable exhaust valve 114 and the controllable intake valve 116 are closed and the captured CO₂ gas may be processed and stored within the CO₂ storage unit 118. Once the CO₂ gas has been vented into the CO₂ storage unit 118, the controllable exhaust valve 114 and the controllable intake valve 116 are reopened to begin another CO₂ extraction processing cycle.

The controllable intake valve 116 controls the intake flow of atmospheric air from the environment through the intake ports 117a-b into the CO₂/O₂ processing unit 115. The CO₂/O₂ processing unit 115 cycles through a set of operating modes as disclosed in detail in regard to FIG. 4. Once the CO₂/O₂ processing unit 115 has captured a sufficient amount of gas, the controllable exhaust valve 114 and the controllable intake valve 116 are closed and the captured CO₂ gas may be processed and stored within the CO₂ storage unit 118. Once the CO₂ gas has been vented into the CO₂ storage unit 118, the controllable exhaust valve 114 and the controllable intake valve 116 are reopened to begin another CO₂ extraction processing cycle.

The pair of intake ports 117a-b passes atmospheric air into the O₂ Tree 101 in order to extract the CO₂. The pair of intake ports 117a-b is coupled to the controllable intake valve 116 creating a path to the CO₂/O₂ processing unit 115. The CO₂/O₂ processing unit 115 cycles through a set of operating modes as disclosed in detail in regard to FIG. 4. Once the CO₂/O₂ processing unit 115 has captured a sufficient amount of CO₂ gas, the controllable exhaust valve 114 and the controllable intake valve 116 are closed and the captured CO₂ gas may be processed and stored within the CO₂ storage unit 118. Once the CO₂ gas has been vented into the CO₂ storage unit 118, the controllable exhaust valve 114 and the controllable intake valve 116 are reopened to begin another CO₂ gas extraction cycle.

The CO₂ storage unit 118 is coupled to the CO₂/O₂ processing unit 115 to accept the vented CO₂ gas for further processing and storage. Disposing of the vented CO₂, may be accomplished in several ways. In a preferred embodiment, the vented CO₂ gas is dissolved into water where it may be pumped into the ground to a depth of 26,561 feet, or 1.2 miles, where it naturally converts to carbonates. Another option is to capture the CO₂ in a container that would be collected at regular intervals; a good option because CO₂ is a useful product to other industries.

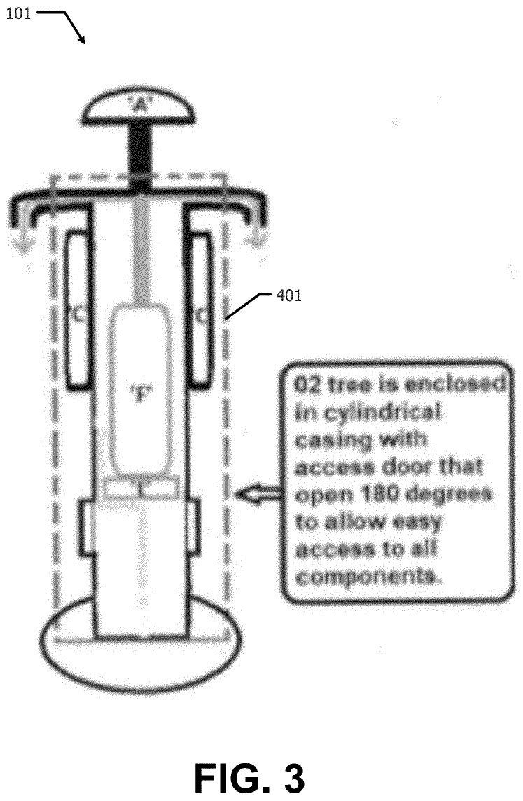

FIG. 3 illustrates the example embodiment with an outside enclosure of the article of manufacture providing an O₂ Tree for removing CO₂ gas from the atmosphere according to the present invention. The O₂ Tree 101 shown in FIG. 3 includes a cylindrical casing 301 around all of the components described above in reference to FIG. 2. The cylindrical casing 301 includes an access door that may open 180 degrees to allow easy access to all components. The cylindrical casing 301 also protects individuals near the O₂ Tree 101 as the CO₂/O₂ processing unit 115 requires heating the captured CO₂ before venting the gas into the CO₂ storage unit 118.

FIG. 4 illustrates a block diagram of an article of manufacture providing an O₂ Tree for removing CO₂ gas from the atmosphere according to the present invention. One embodiment of an O₂ Tree 400 is constructed using an enclosed container 401 having a CO₂ filtering chamber 402 with a fan 403 driven by a fan motor 421 to direct atmospheric air into an intake port 411 and through a filter element 404. The filter element 404 includes a specially developed absorbent which binds the CO₂ from the air. For example, graphene filters are known to capture CO₂ from the air.

The filtered air having the CO₂ removed is expelled as exhaust out of an exhaust port 413. When the filter element 404 has captured the CO₂, the intake port 411 and exhaust port 413 are closed. The CO₂ filtering chamber 402 is heated by a heater element 422 to release the CO₂ from the filter element 404 into the CO₂ filtering chamber 402. A captured CO₂ transfer port 412 may be opened and the fan 403 forces the CO₂ into a CO₂ storage unit 405. The captured CO₂ transfer port 412 is closed before the intake port 411 and the exhaust port 413 are opened and the CO₂ extraction processing cycle continues.

The O₂ Tree 101 is powered by a power supply 420 that is coupled to an external source (not shown), the solar array 414, and one or more rechargeable battery 113a-b. As described above, the power supply 420 will typically operate using the external AC power. When the external source is not available, the rechargeable batteries 113a-b may provide power to operate the O₂ Tree 101. The power supply 420 can recharge the batteries 113a-b using the external source when available and the solar array 414 when needed.

A controller 423 commands the operation of the components within the O₂ Tree 101. The controller 423 sends control signals to the intake port 411, the exhaust port 413, the captured CO₂ transfer port 412, and the fan motor 421 to operate and close as needed. The controller 423 engages the heater 422 during the CO₂ extraction processing cycle to extract the captured CO₂ from the filter 404. The controller 423 comprises an electronic device configured to control the operating state of the intake port 411, the exhaust port 413, and the captured CO₂ transfer port 412, the fan motor 421, and the heater element 422 throughout the CO₂ extraction processing cycle described above.

The CO₂ storage unit 405 is coupled to the captured CO₂ transfer port 412 by a transfer pipe 426 allowing the captured CO₂ to pass to a water carbonizer 424. The captured CO₂ is dissolved into water by the water carbonizer 424. This wastewater containing the CO₂ is pumped by a water pump 425 to an external reservoir location through a number of water pipes 427-428.

After this, the wastewater transports the carbon dioxide to approximately 2,000 meters below the surface of the Earth. The dissolved CO₂ is now left there to naturally convert to carbonates through various mineralization processes with the basalt rock.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture providing an O₂ Tree for removing CO₂ gas from the atmosphere, the O₂ Tree comprises:
a capture chamber having a CO₂/O₂ processing unit;
an intake port into the capture chamber;
an exhaust port from the capture chamber; and
the CO₂/O₂ processing unit comprises:
a captured CO₂ transfer port;
a fan having a fan motor for moving air into and out of the capture chamber through the intake port and the exhaust port;
a filter element for binding with the CO₂ within the capture chamber;
a heater element for raising the temperature of the filter element to release the bound CO₂ from the filter element generating captured CO₂; and
a controller, the controller configured to cause the CO₂/O₂ processing unit to:
open the intake port and the exhaust port;
activate the fan motor to draw atmospheric air into the capture chamber;
after a period of time, close the intake port and the exhaust port and deactivate the fan motor;
activate the heater to raise the filter temperature; and
open the captured CO₂ transfer port causing the captured CO₂ pass out of the capture chamber.

2. The O₂ Tree according to claim 1, wherein the filter element utilizes graphene to bind the CO₂ to the filter element.

3. The O₂ Tree according to claim 1, wherein the O₂ Tree further comprises:
a solar power dome having one or more solar power arrays;
a power supply for suppling electrical power to the O₂ Tree; and
one or more rechargeable batteries.

4. The O₂ Tree according to claim 3, wherein the power supply recharges the one or more rechargeable batteries using the solar arrays.

5. The O₂ Tree according to claim 3, wherein the power supply recharges the one or more rechargeable batteries using an external AC power source.

6. The O₂ Tree according to claim 5, wherein the power supply uses the rechargeable batteries to provide electrical power to the O₂ Tree when the external AC power source is unavailable.
